(19) United States
(12) Patent Application Publication
(10) Pub. No.: US 2026/0288616 A1
(43) Pub. Date: Sep. 24, 2026

(54) PERFORMANCE STATE (PSTATE) CONTROL IN A SYSTEM-ON-CHIP (SOC)

(71) Applicant: QUALCOMM INCORPORATED, San Diego, CA (US)

(72) Inventors: Xiuting Cheng MAN, Austin, TX (US); Mohd Imran BEG, Whitby (CA); Hoan Huu NGUYEN, Cary, NC (US); Nitin MAKHIJA, San Jose, CA (US)

(21) Appl. No.: 19/087,204

(22) Filed: Mar. 21, 2025

(51) Int. Cl. G06F 11/34; G06F 1/08

(52) U.S. Cl. CPC G06F 11/3495; G06F 1/08

(57) ABSTRACT

In a processor system operating at a current performance state (Pstate), a processor may determine a fine-grained target Pstate, including target Pstate parameter values. Control circuitry may then transition through discrete Pstates, which may be stored in a table, from the current Pstate to a discrete Pstate closest to the fine-grained target Pstate. After reaching the discrete Pstate closest to the fine-grained target Pstate, the target Pstate parameter values may be provided to dynamic clock and voltage scaling (DCVS) or other circuitry associated with the processor system.

### DESCRIPTION OF THE RELATED ART

A computing device may include components such as processors, memory, input and output components, etc. Processors may include, for example, central processing units (CPUs), graphics processing units (GPUs), digital signal processors (DSPs), neural processing units (NPUs), etc. Wireless computing devices may also include radio transceiver subsystems, also referred to as modems. The multiple components may be integrated in a “system-on-chip” or “SoC.” Mobile computing devices, such as cellular handsets, automotive computing devices, so-called Internet-of-Things devices, wearable devices, etc., may include SoCs. Power management features may play a significant role in mobile computing devices, as they are generally battery powered and may involve thermal considerations (e.g., a handheld device maintaining a comfortable case temperature).

Power management addresses the competing goals of high performance versus power conservation and thermal mitigation. The amount of power a processor draws is largely a function of voltage and frequency. An example of a power management technique is dynamic clock and voltage scaling (DCVS), also known as dynamic voltage and frequency scaling (DVFS). In DCVS, the clock frequency and voltage supplied to a processor are controllable during runtime and may be adjusted based on operating conditions. For example, the clock frequency and voltage may be adjusted to achieve target levels of processing performance, power consumption, temperature, etc. When conditions indicate that the goal of high processing performance outweighs power saving or thermal mitigation goals, DCVS may increase the clock frequency and voltage. When conditions indicate that the goal of saving power or reducing a temperature outweighs the competing goal of high processing performance, DCVS may reduce the clock frequency and voltage. The term “performance state” or “Pstate” may be used to refer to a setting or combination of parameter values relating to frequency and voltage. There may be multiple Pstates, i.e., different combinations of parameters relating to frequency and voltage, from among which the computing device's power management controller can select to achieve different proportions of performance versus power conservation and thermal mitigation.

The Pstates may be stored in a table (i.e., firmware), with Pstates ranked in order of frequency. To transition from a current Pstate to a target Pstate, the power management controller (e.g., a finite state machine) may transition or step through a series of one or more intermediate Pstates, so that the clock frequency does not jump (i.e., increment or decrement) more than a threshold amount or delta before reaching the target Pstate.

The number of Pstates in the table is finite (i.e., remains fixed in firmware) and may be limited to a reasonable number to meet design goals, such as hardware cost considerations. Accordingly, the frequency differences or deltas between adjacent Pstates may be substantial. The power management controller may select as the target Pstate the Pstate in the table that is closest in frequency to the desired or target frequency.

### SUMMARY OF THE DISCLOSURE

Systems, methods, and other examples of performance state (Pstate) control are disclosed.

An exemplary system for Pstate control in a processor system may include Pstate storage circuitry and control circuitry. The Pstate storage circuitry may be configured to provide a plurality of discrete Pstates. Each discrete Pstate may include a plurality of discrete Pstate parameter values. The control circuitry may be configured to receive an indication of a target Pstate. The indication of the target Pstate may include a plurality of target Pstate parameter values. The control circuitry may further be configured to transition from a current Pstate to a discrete Pstate closest to the target Pstate. The discrete Pstate may be one among a plurality of such discrete Pstates. The control circuitry may still further be configured to provide the target Pstate parameter values to dynamic clock and voltage scaling (DCVS) circuitry associated with the processor system after transitioning to the discrete Pstate closest to the target Pstate.

An exemplary method for Pstate control may include determining a target Pstate, The target Pstate may include a plurality of target Pstate parameter values. The determination may be made by a processor in a processor system. The method may further include transitioning from a current Pstate to a discrete Pstate closest to the target Pstate. The discrete Pstate closest to the target Pstate may be one among a plurality of such discrete Pstates. The transitioning may be controlled by control circuitry. The method may still further include providing the target Pstate parameter values to DCVS circuitry associated with the processor system after transitioning to the discrete Pstate closest to the target Pstate.

An exemplary system-on-chip or “SoC” may include processor circuitry, Pstate storage circuitry, and control circuitry. The processor circuitry may be configured to determine a target Pstate. The target Pstate may include a plurality of target Pstate parameter values. The Pstate storage circuitry may be configured to provide a plurality of discrete Pstates. Each discrete Pstate may include a plurality of discrete Pstate parameter values. The control circuitry may be configured to receive from the processor circuitry an indication of the target Pstate and the plurality of target Pstate parameter values. The control circuitry may further be configured to transition from a current Pstate to a discrete Pstate closest to the target Pstate. The discrete Pstate closest to the target Pstate may be one among a plurality of such discrete Pstates. The control circuitry may further be configured to provide the target Pstate parameter values to dynamic clock and voltage control circuitry associated with the processor system after transitioning to the discrete Pstate closest to the target Pstate.

### BRIEF DESCRIPTION OF THE DRAWINGS

In the Figures, like reference numerals refer to like parts throughout the various views unless otherwise indicated. For reference numerals with letter character designations such as “101A” or “101B”, the letter character designations may differentiate two like parts or elements present in the same Figure. Letter character designations for reference numerals may be omitted when it is intended that a reference numeral encompass all parts having the same reference numeral in all Figures.

FIG. 1 is a block diagram of a portion of a computing device having a fine-grained Pstate control feature, in accordance with exemplary embodiments.

FIG. 2 illustrates a Pstate table, in accordance with exemplary embodiments.

FIG. 3 illustrates a current Pstate register and a target Pstate register, in accordance with exemplary embodiments.

FIG. 4 is a flow diagram illustrating a method for fine-grained Pstate control in a computing device, in accordance with exemplary embodiments.

FIG. 5 is a block diagram of a portable computing device having a fine-grained Pstate control feature, in accordance with exemplary embodiments.

### DETAILED DESCRIPTION

The word “exemplary” is used herein to mean “serving as an example, instance, or illustration.” The word “illustrative” may be used herein synonymously with “exemplary.” Any aspect described herein as “exemplary” is not necessarily to be construed as preferred or advantageous over other aspects.

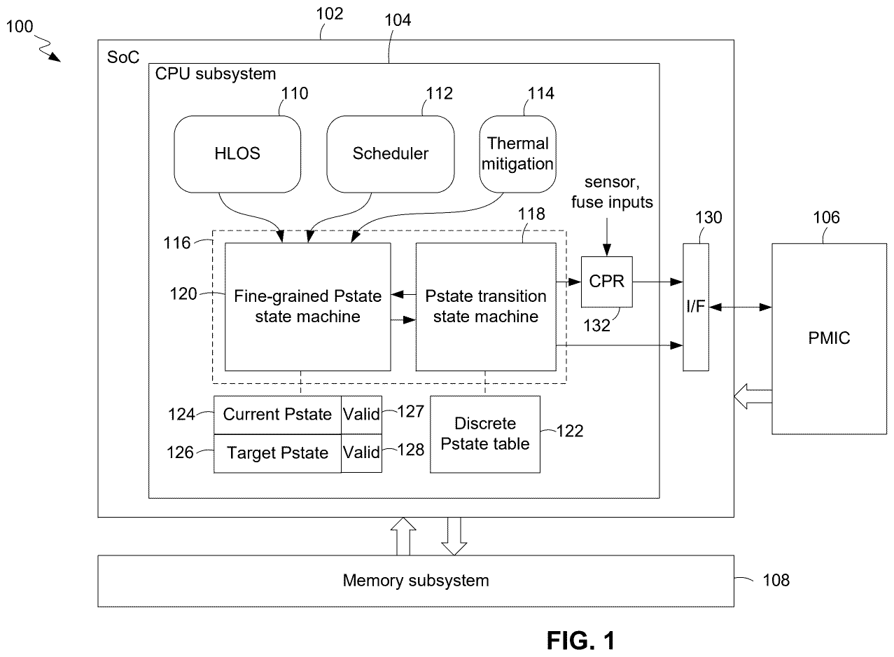

As shown in FIG. 1, in an illustrative or exemplary embodiment a system 100 may include a system-on-chip (SoC) 102. The SoC 102 may include a central processing unit (CPU) subsystem 104, which may comprise multiple cores (not shown). The system 100 may further include a power management integrated circuit (PMIC) 106 and a memory subsystem 108, as well as other subsystems and components (not shown for purposes of clarity). Examples of such other subsystems may include a wireless connectivity subsystem, a graphics processing unit (GPU) subsystem, a digital signal processing (DSP) subsystem, a neural processing unit (NPU) subsystem, etc., or cores thereof. One or more data communication interconnects may couple the subsystems but are not shown for purposes of clarity. The system 100 may be included in a computing device, such as, for example, a cellular telephone or smartphone, a desktop, laptop, palmtop or tablet computer, a so-called Internet-of-Things device, a wearable device, an automotive computing device, etc.

Software elements that may execute on the CPU subsystem 104 may include, for example, a high-level operating system (HLOS) 110, a scheduler 112, and thermal mitigation 114, as well as other software elements (not shown for purposes of clarity). Examples of such other software elements may include application software. Although for purposes of clarity such software elements are depicted in FIG. 1 as stored in or residing in the CPU subsystem 104, it should be understood that such software elements may be retrieved from a source such as the memory subsystem 108 (e.g., in the form of instructions or other code portions) for execution in the CPU subsystem 104 in accordance with conventional computing principles.

The HLOS 110, scheduler 112, and thermal mitigation 114 are examples of software elements that may request a performance state (Pstate). That is, such a software element may include a feature that, based on operating conditions, may algorithmically compare or weigh the goal of high processing performance against competing goals of saving power or reducing temperature (i.e., thermal mitigation) and determine a Pstate that apportions those goals. A Pstate generally corresponds to an operating frequency, as a higher clock frequency generally increases processing performance. For example, when such a software element determines that an increase in processing performance is needed to meet operating condition criteria, such as, for example, low latency for an improved user experience, the software element may request a higher-frequency Pstate than a current Pstate. Or, when such a software element determines that a decrease in processing performance may help meet operating condition criteria, such as, for example, reducing power consumption or temperature, the software element may request a lower-frequency Pstate than a current Pstate.

The HLOS 110, scheduler 112, thermal mitigation 114, or other software element that is configured to request a Pstate may provide such a Pstate request to Pstate state machine circuitry 116. The Pstate state machine circuitry 116 may use dynamic clock and voltage scaling (DCVS) principles to give effect to the requested Pstate. It should be understood that although in the illustrated example this Pstate circuitry comprises one or more finite state machines, in other examples such Pstate circuitry may be of a type other than a state machine or may include a state machine in addition to other circuitry. The Pstate state machine logic or circuitry 116 may include, for example, a Pstate transition state machine 118 and a fine-grained Pstate state machine 120. The Pstate transition state machine 118 may be configured to access a discrete Pstate table 122. The discrete Pstate table 122 may comprise, for example, registers (i.e., Pstate storage circuitry) in the CPU subsystem 104. An example of the discrete Pstate table 122 is described below in further detail. Nevertheless, it may be appreciated here that the discrete Pstate table 122 may be configured to store or indicate a fixed or discrete number of Pstates. The fine-grained Pstate state machine 120 may be configured to access or control a current Pstate register 124 and a target Pstate register 126.

The Pstate state machine circuitry 116, current Pstate register 124 and target Pstate register 126 may together provide control circuitry that stores and otherwise uses a current Pstate and a target Pstate. The target Pstate register 126 and the current Pstate register 124 may include Valid bits 128 and 127, respectively. Although in the illustrated example the Pstate state machine circuitry 116 may include both the Pstate transition state machine 118 and the fine-grained Pstate state machine 120 or otherwise include more than one state machine, in other examples such Pstate state machine logic or circuitry may include only a single state machine, more than two state machines, or other circuitry.

In response to a Pstate request received from one of the above-described software elements or other source of Pstate requests, the Pstate state machine circuitry 116 may provide Pstate information or values of Pstate parameters. These Pstate parameter values may include one or more values corresponding to voltages or frequencies, or settings for circuitry configured to provide voltages, frequencies, etc. Such Pstate parameter values may be provided by the CPU subsystem 104 to, for example, the PMIC 106 via interface circuitry 130. Alternatively or in addition, such Pstate parameter values may be provided to various other consumers or users of Pstate parameter values, such as core power reduction (CPR) circuitry 132 of the SoC 102. CPR is a technology that scales power (i.e., voltage) supplied to a processing core up or down based on inputs that may include, for example, readings from frequency, temperature or other sensors (not shown) on the SoC 102 and settings read from efuses (that have been previously written, e.g., during chip production). The efuse values or settings may indicate, for example, compensation for chip manufacturing process variations, chip aging degradation, etc. The CPR circuitry 132 may determine the operating frequency of the SoC 102 using sensors and provide a supply voltage modification factor to the PMIC 106 based on the sensor readings, efuse values or other information. That is, Pstate parameter values (or values based on Pstate parameter values, such as an output of the CPR circuitry 132) may be provided to the PMIC 106. Based on the Pstate parameter values (or values based on Pstate parameter values), the PMIC 106 may power one or more voltage rails supplied to the SoC 102 and provide one or more clock frequencies.

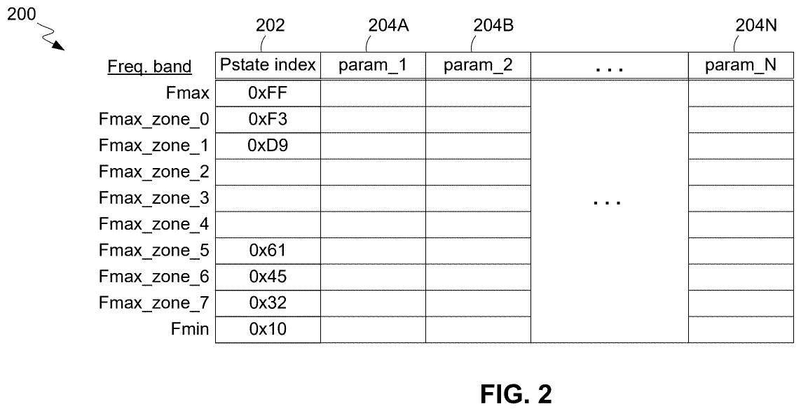

As shown in FIG. 2, a Pstate table 200 may indicate Pstate parameter values associated with Pstates. The Pstate table 200 may be an example of the above-described discrete Pstate table 122 (FIG. 1). The Pstate table 200 may include any number of Pstates, represented by Pstate indices or values listed in, for example, a first column 202 of the Pstate table 200. That is, in the illustrated example each row in the Pstate table 200 is associated with the Pstate index in the first column 202 of that row. Note that there are a discrete or finite number of Pstates (rows) in the Pstate table 200.

Each Pstate index may correspond to or represent a frequency, shown in the illustrated example in hexadecimal notation. In the illustrated example, at the lower-frequency end of the Pstate table 200: a Pstate index of 0×10 may represent a lowest or minimum frequency (Fmin); a Pstate index of 0×32 may represent the next-higher frequency after 0×10; a Pstate index of 0×45 may represent the next-higher frequency after 0×32; a Pstate index of 0×61 may represent the next-higher frequency after 0×45; etc. At the higher-frequency end of the Pstate table 200: a Pstate index of 0×FF may represent a highest or maximum frequency (Fmax); a Pstate index of 0×F3 may represent the next-lower frequency after 0×FF; a Pstate index of 0×D9 may represent the next-lower frequency after 0×F3; etc. It should be understood that the Pstate indices listed in the Pstate table 200 are intended only as examples and may have other values in other examples. Nevertheless, it may be noted that the Pstate indices may be listed in the exemplary Pstate table 200 in a monotonically increasing (or decreasing) order. Also, note that Pstate indices between 0×61 and 0×D9 are not shown in this example, and could have any values consistent with such an order. The increment or delta between successive Pstates (in successive rows in this table example) may be substantial, such as, for example, 25 megahertz (MHz) or 100 MHz, etc.

It may also be noted in the exemplary Pstate table 200 that the Pstate indices may represent the boundaries of frequency bands or “zones.” For example, the Pstate index 0×F3 may be the maximum of a first zone (Fmax_zone_0), the Pstate index 0×D9 may be the maximum of a second zone (Fmax_zone_1), etc. The zones may represent, for example, transition points that Pstate changes (from lower Pstate to higher Pstate or from higher Pstate to lower Pstate) must go through to maintain functionality of the underlying logic circuitry. Pstate changes that cross a zone may require more extensive adjustments (e.g., memory timing margins, fuse values, etc.) than Pstate changes that do not cross a zone.

The Pstate table 200 may also include any number of Pstate parameters associated with each Pstate index. In the illustrated example, a second column 204A of the Pstate table 200 may indicate a first Pstate parameter (param_1), a third column 204B of the Pstate table 200 may indicate a second Pstate parameter (param_2), etc., through a last column 204N of the Pstate table 200, which may indicate an Nth Pstate parameter (param_N). Each row of the exemplary Pstate table 200 thus contains a Pstate index and the one or more Pstate parameters associated with that Pstate index. The Pstate parameters may comprise settings for various circuitry configured to provide voltages, frequencies, etc. Frequency-related Pstate parameters may include, for example, settings for phase-locked loop clock signal generator circuitry (not shown).

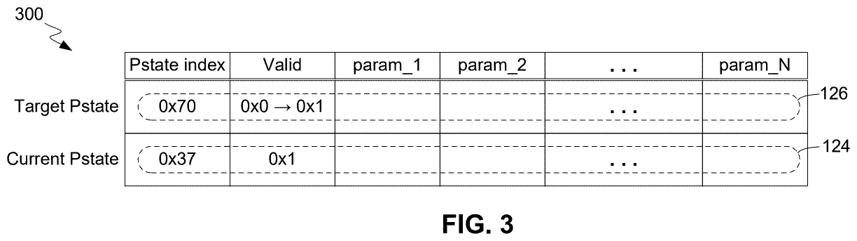

In FIG. 3, a table 300 illustrates an example of the above-described (FIG. 1) current Pstate register 124 and target Pstate register 126. The table 300 may include the Pstate index of a target Pstate and the Pstate parameters (described above with regard to FIG. 2) of that target Pstate. The table 300 may also include the Pstate index of a current Pstate and the Pstate parameters of that current Pstate. The table 300 may further include Valid indications as described above (FIG. 1) with regard to the current Pstate register 124 and target Pstate register 126. The Valid indications (e.g., bits) may be used in a manner described below.

Although the Pstate table 200 (FIG. 2) contains only a finite or discrete number of Pstates, the solutions described herein may provide additional Pstates that are not in the table 200. The following example of operation of the system 100 (FIG. 1) illustrates how such additional or “fine-grained” Pstates may be provided. A fine-grained Pstate is a Pstate that is not in the table 200. That is, neither the fine-grained Pstate index nor the fine-grained Pstate parameters associated with that fine-grained Pstate index are in the Pstate table 200. A discrete Pstate is a Pstate that is in the Pstate table 200. One or more fine-grained Pstates may lie between two of the discrete Pstates in the Pstate table 200 (e.g., between two adjacent rows of the table 200). The capability of selecting from among any number of fine-grained Pstates may enable more precise control in some use cases than selecting from among only the discrete Pstates in the Pstate table 200. As an example, when the thermal mitigation software element 114 (FIG. 1) determines that a measured temperature is at risk of exceeding a threshold, the CPU subsystem 104 may be throttled by clock frequency reduction or by a combination of clock frequency and voltage reduction. The thermal mitigation software element 114 may determine that, based on operating conditions, chip (part) properties, etc., a fine-grained Pstate may provide a more optimized tradeoff or balance between workload performance and temperature than any of the discrete Pstates in the Pstate table 200. Or, in another example, when the HLOS 110 or scheduler 112 (FIG. 1) is requesting a Pstate for a scheduled workload, the HLOS 110 or scheduler 112 may determine that a fine-grained Pstate may provide a more optimized performance level that meets physical constraints (e.g., current, temperature, etc.) than any of the discrete Pstates in the Pstate table 200. Although in some examples the Pstate table 200 may be included within a CPU subsystem as in the example described above with regard to FIG. 1 (e.g., Pstate table 122), in other examples such a Pstate table may be provided in any other manner, such as in firmware or software, in dynamic random access memory (DRAM) or other off-SoC memory, etc. Also, in some examples fine-grained Pstates may be determined in advance of a Pstate request, such as at a processor system boot time, and in such examples the fine-grained Pstates may be stored or otherwise provided in a similar manner.

In an example of operation, one of the above-described software entities 110, 112, 114, etc., or other source of a Pstate request may provide a fine-grained Pstate request to the Pstate state machine circuitry 116 (FIG. 1). As the Pstate parameters for a fine-grained Pstate are not in the Pstate table 200 (FIG. 2), the software entity requesting the fine-grained Pstate may write (i.e., store) the fine-grained Pstate index and the fine-grained Pstate parameters for that Pstate index to the target Pstate register 126 (FIG. 1). For example, as shown in FIG. 3, the software entity may have determined that selecting a frequency (i.e., Pstate index) of 0×70 would provide better operating results than any of the frequencies (i.e., Pstate indices) in the Pstate table 200, such as the next-closest Pstate index 0×61. Accordingly, as shown in FIG. 3, the software entity requesting the fine-grained Pstate may write 0×70 to the Pstate index portion of the target Pstate register 126 (FIG. 1) and may write the fine-grained Pstate parameters for a Pstate index of 0×70 to the Pstate parameter portions of the target Pstate register 126. The software entity requesting the fine-grained Pstate may determine the fine-grained Pstate parameters for the selected or target fine-grained Pstate in any manner, such as, for example, interpolating between discrete Pstate parameters in the Pstate table 200. The fine-grained Pstate parameters may be determined at any time, such as dynamically at the time the software entity requests the fine-grained Pstate or, alternatively, in advance of that time, such as during an initialization phase (e.g., during a processor system boot sequence). The completion of writing the fine-grained Pstate index and all corresponding fine-grained Pstate parameters to the target Pstate register 126 may be referred to as the fine-grained Pstate (index and corresponding parameters) having been set or programmed.

As shown in FIG. 3, in this example the target Pstate is set to a Pstate index of 0×70 while the current Pstate is 0×37. The current Pstate in this example represents the frequency at which the CPU subsystem 104 is then operating. The software entity requesting the fine-grained Pstate may change the Valid bit in the target Pstate register 126 from 0×0 to 0×1 after the software entity has written the fine-grained Pstate parameters to the target Pstate register 126, thereby indicating that the fine-grained Pstate has been set. Then, the software entity may change the Valid bit in the current Pstate register 124 from 0×1 to 0×0 (not shown in FIG. 3).

In response to the fine-grained Pstate request received by the Pstate state machine circuitry 116 (FIG. 1), the Pstate state machine circuitry 116 may incrementally change or transition from the current Pstate to the target Pstate. In this example, the target Pstate of 0×70 is higher than the current Pstate of 0×37, so the Pstate state machine circuitry 116 may first step from the current Pstate to the next-highest discrete Pstate (in the table 200), which is the Pstate index 0×45. Then, the Pstate state machine circuitry 116 may step from the Pstate index 0×45 to the next-highest discrete Pstate (in the table 200), which is 0×61. Each time the Pstate state machine circuitry 116 steps to another discrete Pstate, the Pstate state machine circuitry 116 may push or provide the Pstate parameters corresponding to that discrete Pstate to the components that use those Pstate parameters, such as, for example, the CPR circuitry 132 (FIG. 1), the interface circuitry 130 to the PMIC 106, etc. As it may take some amount of time for the software entity requesting the fine-grained target Pstate to determine and set the corresponding fine-grained target Pstate parameters (i.e., complete writing them to the target Pstate register 126), the Pstate state machine circuitry 116 may proceed with this transitioning or stepping through discrete Pstates concurrently with the determining and setting of the fine-grained target Pstate parameters.

There may be advantages to incrementally changing or stepping from one discrete Pstate to the next discrete Pstate in the above-described manner rather than jumping over one or more intermediate discrete Pstates between the current Pstate and the target Pstate. One such advantage may relate to components that are intolerant to large changes in voltage or frequency while they are in operation, such as, for example, some memory components. If the frequency increment or delta between discrete Pstates is, for example, 25 MHz but a component may be prone to improper operation if its operating frequency were rapidly changed by more than 25 MHz, it may be beneficial to change the operating frequency by steps of no more than 25 MHz. There also may be advantages to incrementally changing or stepping from one discrete Pstate to the next discrete Pstate until a discrete Pstate closest to the target Pstate is reached rather than stepping through all intermediate fine-grained Pstates between the current Pstate and target Pstate, and such advantages may include, for example, shorter transition latency and higher performance.

When the Pstate state machine circuitry 116 has transitioned from the current Pstate to a discrete Pstate closest to the target Pstate, such as 0×61 in the example shown in FIG. 3, then the Pstate state machine circuitry 116 may examine the Valid bit in the target Pstate register 126. If the Pstate state machine circuitry 116 has transitioned from the current Pstate to the discrete Pstate closest to the target Pstate and determined that the Valid bit in the target Pstate register 126 is set (i.e., Valid=0×1), then the Pstate state machine circuitry 116 may further transition to the target Pstate. That is, the Pstate state machine circuitry 116 may push or provide the Pstate parameters from the target Pstate register 126 to the components that use those Pstate parameters, such as, for example, the CPR circuitry 132 (FIG. 1).

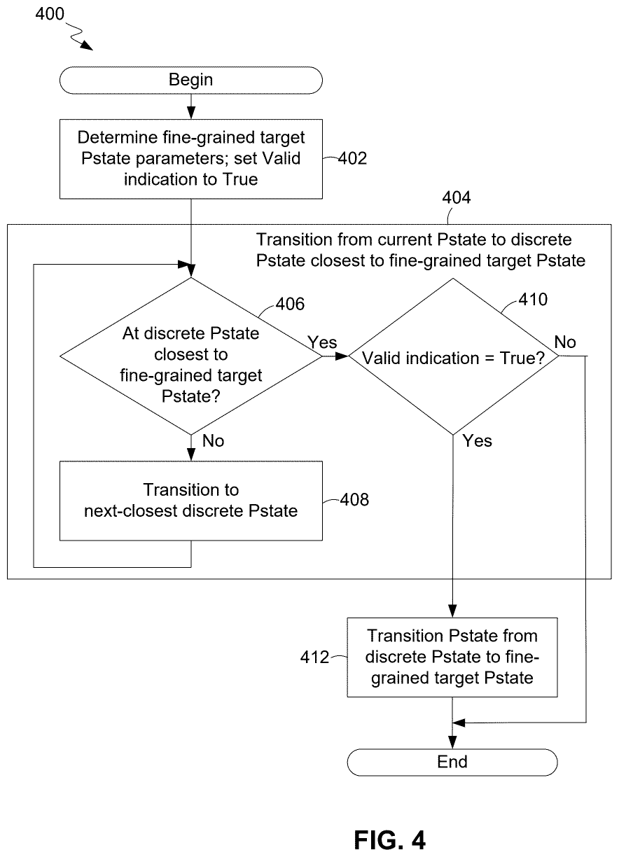

In FIG. 4, a method 400 for Pstate control is illustrated in flow diagram form. As indicated by block 402, the method 400 may include determining a target Pstate. For example, a software entity executing on a processor may provide a request for a target Pstate. The target Pstate may be a fine-grained Pstate. Determining the target Pstate may include determining a plurality of fine-grained target Pstate parameter values. The fine-grained target Pstate parameter values may be determined in any manner, such as, for example, interpolating between discrete Pstate parameter values. The fine-grained target Pstate parameter values may be determined at any time, such as dynamically (in association with the request for the target Pstate) or, alternatively, in advance of the request, such as at a processor system boot time. A Valid indication (e.g., a register bit) associated with the target Pstate may be provided to indicate that the target P-state parameters have been set and are thus ready to provide or push to circuitry that uses Pstate parameter values as inputs. The determination of the fine-grained target Pstate may be made by a processor or processor subsystem, under control of a software entity, such as, for example, a high-level operating system, a scheduler, thermal mitigation software, etc.

As indicated by block 404, the method 400 may include transitioning from a current Pstate to the discrete Pstate closest to the fine-grained target Pstate. A discrete Pstate comprises discrete Pstate parameter values different from the target Pstate parameter values. In an example in which the discrete Pstates are provided by a table, this means that the target Pstate parameter values are not in the table. This transitioning may occur or begin while the target P-state parameters are being determined and set. The transitioning among discrete Pstates may be controlled by, for example, state machine circuitry.

Block 404 may include determining whether the discrete Pstate closest to the fine-grained target Pstate has been reached, as indicated by block 406. If the discrete Pstate closest to the fine-grained target Pstate has not been reached, then a transition to the next-closest Pstate to the fine-grained target Pstate may be performed, as indicated by block 408, and the determination of block 406 may be repeated. When it is determined that the discrete Pstate closest to the fine-grained target Pstate has been reached, then as indicated by block 410 it may be determined whether the Valid indication associated with the target Pstate indicates that the target P-state parameters have been determined and set (e.g., Valid=True, Valid=0×1, etc.).

If it is determined (block 410) that the Valid indication indicates that the target P-state parameters have been determined and set, then as indicated by block 412 a final transition from the discrete Pstate closest to the fine-grained target Pstate to the fine-grained target Pstate may be performed. This transition to the fine-grained target Pstate may include providing the target Pstate parameter values to circuitry that uses the target Pstate parameter values, such as CPR circuitry, other DCVS circuitry, a PMIC, or any other circuitry associated with controlling power and/or clock frequencies supplied to the processor system. The transitioning to the fine-grained target Pstate may be controlled by, for example, state machine circuitry. The Valid indication being set (i.e., indicating that all target P-state parameters have been determined and set) may serve as a condition for proceeding. For example, the Pstate state machine circuitry 116 (FIG. 1) or other control circuitry may be configured to refrain from providing the target Pstate parameter values to DCVS circuitry unless the Valid indication is set.

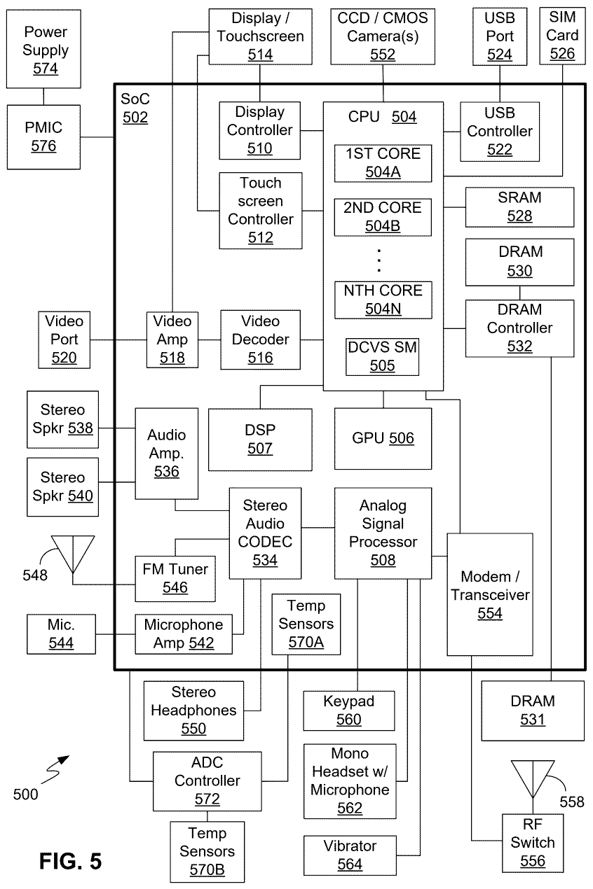

FIG. 5 illustrates an example of a portable computing device (PCD) 500, in which exemplary embodiments of systems, methods, and other examples of the above-described Pstate control may be provided. The PCD 500 may be, for example, a laptop or palmtop computer, cellular telephone or smartphone, personal digital assistant, navigation device, smartbook, portable game console, satellite telephone, automotive device, Internet-of-Things (IoT) device, etc.

The PCD 500 may include an SoC 502. The SoC 502 may be an example of above-described SoC 102 (FIG. 1). The SoC 502 may include a CPU 504, a GPU 506, a digital signal processor (DSP) 507, an analog signal processor 508, a modem/modem subsystem 554, or other processors. The CPU 504 may include one or more CPU cores, such as a first CPU core 504A, a second CPU core 504B, etc., through an Nth CPU core 504N.

The CPU 504 may be an example of the CPU subsystem 104 described above with regard to FIG. 1. Accordingly, the CPU 504 may include DCVS state machine circuitry 505, which may be an example of the above-describe Pstate state machine circuitry 116 (FIG. 1). Although not shown in FIG. 5 for purposes of clarity, the CPU 504 may include Pstate tables (e.g., registers or other data storage circuitry) as described above with regard to FIG. 1, and also may include a current Pstate register and fine-grained target Pstate register with respective Valid bits.

A display controller 510 and a touch-screen controller 512 may be coupled to the CPU 504. A touchscreen display 514 external to the SoC 502 may be coupled to the display controller 510 and the touch-screen controller 512. The PCD 500 may further include a video decoder 516 coupled to the CPU 504. A video amplifier 518 may be coupled to the video decoder 516 and the touchscreen display 514. A video port 520 may be coupled to the video amplifier 518. A universal serial bus (USB) controller 522 may also be coupled to CPU 504, and a USB port 524 may be coupled to the USB controller 522. A subscriber identity module (SIM) card 526 may also be coupled to the CPU 504.

The CPU 504 may be coupled to one or more memories, with which the CPU 504 or other processors may initiate memory transactions. The one or more memories may include both volatile and non-volatile memories. Examples of volatile memories may include static random access memory (SRAM) 528 and dynamic random access memory (DRAM) 530 and 531. Such memories may be internal to the SoC 502, as in the case of the SRAM 528 and DRAM 530, or external to the SoC 502, as in the case of the DRAM 531. A DRAM controller 532 coupled to the CPU 504 may control the writing of data to, and reading of data from, the DRAMs 530 and 531.

A stereo audio CODEC 534 may be coupled to the analog signal processor 508. Further, an audio amplifier 536 may be coupled to the stereo audio CODEC 534. First and second stereo speakers 538 and 540, respectively, may be coupled to the audio amplifier 536. In addition, a microphone amplifier 542 may be coupled to the stereo audio CODEC 534, and a microphone 544 may be coupled to the microphone amplifier 542. A frequency modulation (FM) radio tuner 546 may be coupled to the stereo audio CODEC 534. An FM antenna 548 may be coupled to the FM radio tuner 546. Further, stereo headphones 550 may be coupled to the stereo audio CODEC 534. Other devices that may be coupled to the CPU 504 include one or more digital (e.g., CCD or CMOS) cameras 552.

The RF transceiver or modem subsystem 554 may be coupled to the analog signal processor 508 and the CPU 504. An RF switch 556 may be coupled to the modem subsystem 554 and an RF antenna 558. In addition, a keypad 560, a mono headset with a microphone 562, and a vibrator device 564 may be coupled to the analog signal processor 508.

The SoC 502 may have one or more internal or on-chip thermal sensors 570A and may be coupled to one or more external or off-chip thermal sensors 570B. An analog-to-digital converter (ADC) controller 572 may convert voltage drops produced by the thermal sensors 570A and 570B to digital signals. A power supply 574 and a power management integrated circuit (PMIC) 576 may supply power to the SoC 502. The PMIC 576 may be an example of the PMIC 106 described above with regard to FIG. 1.

Implementation examples are described in the following numbered clauses.

1. A system for performance state (Pstate) control, comprising:
Pstate storage circuitry configured to provide a plurality of discrete Pstates, each discrete Pstate including a plurality of discrete Pstate parameter values; and
control circuitry configured to receive an indication of a target Pstate including a plurality of target Pstate parameter values, the control circuitry further configured to transition from a current Pstate to a discrete Pstate closest to the target Pstate from among a plurality of discrete Pstates, wherein the discrete Pstate parameter values differ from the target Pstate parameter values, the control circuitry further configured to provide the target Pstate parameter values to dynamic clock and voltage control circuitry associated with the processor system after transitioning to the discrete Pstate closest to the target Pstate.

2. The system of clause 1, further comprising a processor configured to store the plurality of target Pstate parameter values and to set a Valid indication after storing the plurality of target Pstate parameters, wherein the control circuitry is further configured to confirm the Valid indication after transitioning to the discrete Pstate closest to the target Pstate, and wherein the control circuitry is configured to refrain from providing the target Pstate parameter values to dynamic clock and voltage control circuitry unless the Valid indication is set.

3. The system of clause 2, wherein the Pstate storage circuitry comprises register circuitry, and the control circuitry is configured to receive the indication of the target Pstate from a software entity executing on the processor.

4. The system of clause 2 or 3, wherein the Pstate storage circuitry represents a table of the plurality of discrete Pstates and corresponding discrete Pstate parameters.

5. The system of clause 3 or 4, wherein the register circuitry includes a register bit configured to store the Valid indication.

6. The system of any of clauses 1-5, wherein the control circuitry is configured to store the current Pstate and the target Pstate in register circuitry.

7. The system of any of clauses 1-6, wherein the control circuitry comprises finite state machine circuitry.

8. The system of clause 7, wherein the Pstate storage circuitry comprises register circuitry, and the finite state machine circuitry and the register circuitry are included in a system-on-chip (SoC).

9. A method for performance state (Pstate) control in a processor system, comprising:
determining, by a processor, a target Pstate including a plurality of target Pstate parameter values;
transitioning, by control circuitry, from a current Pstate to a discrete Pstate closest to the target Pstate from among a plurality of discrete Pstates, wherein the discrete Pstate includes discrete Pstate parameter values different from the target Pstate parameter values; and
providing the target Pstate parameter values to dynamic clock and voltage control circuitry associated with the processor system after transitioning to the discrete Pstate closest to the target Pstate.

10. The method of clause 9, further comprising:
storing, by the processor, the plurality of target Pstate parameter values in register circuitry;
setting a Valid indication after storing the plurality of target Pstate parameter values; and
confirming the Valid indication after transitioning to the discrete Pstate closest to the target Pstate, wherein providing the target Pstate parameter values to dynamic clock and voltage control circuitry is not performed unless the Valid indication is set.

11. The method of clause 9 or 10, wherein the plurality of discrete Pstates are included in a table.

12. The method of clause 11, wherein the table is provided in register circuitry.

13. The method of any of clauses 9-12, wherein the current Pstate and the target Pstate are provided in register circuitry.

14. The method of any of clauses 9-13, wherein the control circuitry comprises finite state machine circuitry.

15. The method of clause 14, wherein the finite state machine circuitry and the processor are included in a system-on-chip (SoC).

16. A system-on-chip (SoC), comprising: processor circuitry configured to determine a target performance state (Pstate) including a plurality of target Pstate parameter values;
Pstate storage circuitry to provide a plurality of discrete Pstates, each discrete Pstate including a plurality of discrete Pstate parameter values; and
control circuitry configured to receive from the processor circuitry an indication of the target Pstate and the plurality of target Pstate parameter values, the control circuitry further configured to transition from a current Pstate to a discrete Pstate closest to the target Pstate from among a plurality of discrete Pstates, wherein the discrete Pstate parameter values differ from the target Pstate parameter values, the control circuitry further configured to provide the target Pstate parameter values to dynamic clock and voltage control circuitry associated with the processor system after transitioning to the discrete Pstate closest to the target Pstate.

17. The SoC of clause 16, wherein the Pstate storage circuitry represents a table of the plurality of discrete Pstates and corresponding discrete Pstate parameters.

18. The SoC of clause 16 or 17, wherein the control circuitry comprises finite state machine circuitry.

19. The SoC of any of clauses 16-18, further comprising a target Pstate register configured to store the plurality of target Pstate parameter values.

20. The SoC of clause 19, wherein the target Pstate register includes a bit configured to store a Valid indication, wherein the control circuitry is further configured to confirm the Valid indication after transitioning to the discrete Pstate closest to the target Pstate, and wherein the control circuitry is configured to refrain from providing the target Pstate parameter values to dynamic clock and voltage control circuitry unless the Valid indication is set.

Alternative embodiments will become apparent to one of ordinary skill in the art to which the invention pertains. Therefore, although selected aspects have been illustrated and described in detail, it will be understood that various substitutions and alterations may be made therein.

What is claimed is:

1. A system for performance state (Pstate) control, comprising:
Pstate storage circuitry configured to provide a plurality of discrete Pstates, each discrete Pstate including a plurality of discrete Pstate parameter values; and
control circuitry configured to receive an indication of a target Pstate including a plurality of target Pstate parameter values, the control circuitry further configured to transition from a current Pstate to a discrete Pstate closest to the target Pstate from among a plurality of discrete Pstates, wherein the discrete Pstate parameter values differ from the target Pstate parameter values, the control circuitry further configured to provide the target Pstate parameter values to dynamic clock and voltage control circuitry associated with the processor system after transitioning to the discrete Pstate closest to the target Pstate.

2. The system of claim 1, further comprising a processor configured to store the plurality of target Pstate parameter values and to set a Valid indication after storing the plurality of target Pstate parameters, wherein the control circuitry is further configured to confirm the Valid indication after transitioning to the discrete Pstate closest to the target Pstate, and wherein the control circuitry is configured to refrain from providing the target Pstate parameter values to dynamic clock and voltage control circuitry unless the Valid indication is set.

3. The system of claim 2, wherein the Pstate storage circuitry comprises register circuitry, and the control circuitry is configured to receive the indication of the target Pstate from a software entity executing on the processor.

4. The system of claim 3, wherein the Pstate storage circuitry represents a table of the plurality of discrete Pstates and corresponding discrete Pstate parameters.

5. The system of claim 4, wherein the register circuitry includes a register bit configured to store the Valid indication.

6. The system of claim 1, wherein the control circuitry is configured to store the current Pstate and the target Pstate in register circuitry.

7. The system of claim 1, wherein the control circuitry comprises finite state machine circuitry.

8. The system of claim 7, wherein the Pstate storage circuitry comprises register circuitry, and the finite state machine circuitry and the register circuitry are included in a system-on-chip (SoC).

9. A method for performance state (Pstate) control in a processor system, comprising:
determining, by a processor, a target Pstate including a plurality of target Pstate parameter values;
transitioning, by control circuitry, from a current Pstate to a discrete Pstate closest to the target Pstate from among a plurality of discrete Pstates, wherein the discrete Pstate includes discrete Pstate parameter values different from the target Pstate parameter values; and
providing the target Pstate parameter values to dynamic clock and voltage control circuitry associated with the processor system after transitioning to the discrete Pstate closest to the target Pstate.

10. The method of claim 9, further comprising:
storing, by the processor, the plurality of target Pstate parameter values in register circuitry;
setting a Valid indication after storing the plurality of target Pstate parameter values; and
confirming the Valid indication after transitioning to the discrete Pstate closest to the target Pstate, wherein providing the target Pstate parameter values to dynamic clock and voltage control circuitry is not performed unless the Valid indication is set.

11. The method of claim 9, wherein the plurality of discrete Pstates are included in a table.

12. The method of claim 11, wherein the table is provided in register circuitry.

13. The method of claim 9, wherein the current Pstate and the target Pstate are provided in register circuitry.

14. The method of claim 9, wherein the control circuitry comprises finite state machine circuitry.

15. The method of claim 14, wherein the finite state machine circuitry and the processor are included in a system-on-chip (SoC).

16. A system-on-chip (SoC), comprising:
processor circuitry configured to determine a target performance state (Pstate) including a plurality of target Pstate parameter values;
Pstate storage circuitry to provide a plurality of discrete Pstates, each discrete Pstate including a plurality of discrete Pstate parameter values; and
control circuitry configured to receive from the processor circuitry an indication of the target Pstate and the plurality of target Pstate parameter values, the control circuitry further configured to transition from a current Pstate to a discrete Pstate closest to the target Pstate from among a plurality of discrete Pstates, wherein the discrete Pstate parameter values differ from the target Pstate parameter values, the control circuitry further configured to provide the target Pstate parameter values to dynamic clock and voltage control circuitry associated with the processor system after transitioning to the discrete Pstate closest to the target Pstate.

17. The SoC of claim 16, wherein the Pstate storage circuitry represents a table of the plurality of discrete Pstates and corresponding discrete Pstate parameters.

18. The SoC of claim 16, wherein the control circuitry comprises finite state machine circuitry.

19. The SoC of claim 16, further comprising a target Pstate register configured to store the plurality of target Pstate parameter values.

20. The SoC of claim 19, wherein the target Pstate register includes a bit configured to store a Valid indication, wherein the control circuitry is further configured to confirm the Valid indication after transitioning to the discrete Pstate closest to the target Pstate, and wherein the control circuitry is configured to refrain from providing the target Pstate parameter values to dynamic clock and voltage control circuitry unless the Valid indication is set.
